(19) United States
(12) Patent Application Publication
(10) Pub. No.: US 2023/0018886 A1
(43) Pub. Date: Jan. 19, 2023

(54) SYSTEM TO IDENTIFY PURCHASERS

(71) Applicant: KonectAi, LLC, Houston, TX (US)

(72) Inventor: Inderpal Lehal, Delta (CA)

(73) Assignee: KonectAi, LLC, Houston, TX (US)

(21) Appl. No.: 17/374,513

(22) Filed: Jul. 13, 2021

(51) Int. Cl. G06Q 30/02; G06Q 30/06; H04L 12/58; G06N 5/04

(52) U.S. Cl. CPC G06Q 30/0277; G06Q 30/0619; H04L 51/02; G06N 5/04

(57) ABSTRACT

A method of utilizing an artificial intelligence, AI, having language recognition software allowing the AI to have humanistic characteristics while interacting with an online shopper. The AI interacts with a multiplicity of online shoppers concurrently and in real time to determine the validity of the shopper's contact information and the shopper's level of interest in the product. The AI will again interact with the multiplicity of shoppers, concurrently and in real time, and interact with the shoppers and the appropriate salespersons to make connections between the online shoppers and the salespersons within minutes of the online shoppers engaging in an online conversation with the AI. If either the shopper or the salesperson in any single interaction is unavailable, then the AI will attempt to schedule a future connection between the shopper and a salesperson. The AI will continue to follow up between the online shopper and salespersons until a connection is made or the online shopper indicates they are no longer interested.

### BACKGROUND

Generally, marketing is now conducted in an online environment where thousands of shoppers dispersed over tens of thousands of square miles may browse through a variety of online resources when searching for a particular product that is suitable for the shopper's requirements. However, in many instances, the online resources available to the shoppers lack details as to variations and purchase options between products. In an effort to streamline the shopping process, current online product providers include an option for the shopper to provide contact information to the product provider.

Once the shopper's contact information has been provided to the product provider, the information is sent to a customer relationship management system where it can then be used by a salesperson at the business development center or BDC to attempt to contact the shopper. Because of the overwhelming number of shoppers who have provided their contact information, the shoppers' contact information may sit in the customer relationship management system for up to several days before a person at the BDC is able to make an attempt to contact the shopper. By the time the first live contact is made with the shopper, the shopper's information may be stale due to the shopper's lack of continued interest, or the shopper may have already purchased a less optimally suited but locally available product. The first attempt to contact the shopper depends upon the contact information provided by the shopper and may be by email, text, or phone call.

It has been found that, generally, roughly half of shoppers' contact information is inaccurate such that persons at the BDC waste valuable time and effort attempting to contact shoppers using this inaccurate information. Even in instances when accurate shoppers' contact information has been provided, phone calls often go to voicemail, texts are often unanswered, and shoppers often don't check their email regularly, all leading to wasted time by persons at the BDC. Further, when the attempted first contact is unsuccessful, one or more follow-up attempts are often made by persons at the business development center to connect with the shopper. Again, most of these attempts are unsuccessful, all wasting valuable time.

### SUMMARY

The following is an embodiment of the present invention. Again, today, thousands of shoppers dispersed over tens of thousands of square miles may browse through a variety of online resources when searching for a particular product that is suitable for the shopper's requirements. Due to the volume as well as the physical distance between shoppers and the various products that the shoppers are searching for, it has been found to be essentially impossible for a salesperson or even a team of salespersons to contact each shopper in real time while such shoppers are online. To solve this problem, as shoppers search through the various online resources for their particular product, a computer hosting an artificial intelligence or AI initiates a conversation with each shopper. The AI uses language recognition software to emulate a person. It has been found that shoppers are more likely to provide their contact information to a person than to a computer system. Therefore, the AI uses the language recognition software to engage in humanistic conversations with the shoppers in search of certain nuanced responses from the shoppers to better direct the shoppers to the appropriate salespersons, which may be any one of several appropriate salespersons. The AI generally begins the conversation by introducing itself with a name. For example, the AI may begin by stating, “Hi, my name is “Robert.” I see you're looking for a product”, although, any name would do. Shoppers will then generally respond by introducing themselves by name. The AI may then follow-up by asking for the shopper's contact information, including, but not limited to, phone number and/or email address, specifics related to the product the shopper is searching for, and/or a time and/or date to contact the shopper.

Once the AI has received a phone number and/or email address, or shortly thereafter, the AI will test the phone number and/or email address to check whether or not the phone number and/or email address is a working phone number or email address. To accomplish this test, the AI will either call the phone number or ask the shopper by text or email to confirm their preferred contact method, i.e. text, email, or phone call. Once confirmed, the AI will proceed to dialogue with the shopper in real-time.

The real-time dialogue is designed to gather additional customer information from the shopper through a series of steps. Again, the first text, email, or phone call by the AI determines whether or not the contact information is a prospective lead or a dead end. If the contact information proves not to be a working phone number or email address, the lead is considered a dead end and the contact information is not added to the customer relationship management system. If the contact information is confirmed to be a working phone number or email address but the shopper does not respond to the AI's test correspondence, then the AI sends the contact information to the customer relationship management system for follow-up by the AI. If the contact information is confirmed to be a working phone number or email address and the shopper responds to the AI's test correspondence, then, the AI sends the contact information to the customer relationship management system, for follow-up by live person in the business development center.

If the AI has proceeded to engage in a real-time humanistic dialogue with the shopper, then the AI will attempt to determine the shopper's interest level in the product. The AI will prioritize shoppers whose interest level is determined to be high and, if that is the case, the AI will attempt to immediately connect the shopper with a salesperson, or, if no salesperson is immediately available, the AI will schedule a follow-up phone call with a salesperson based upon the shopper's interest level in the product, the geographic location of the product, and the geographic location of the salesperson. If the shopper's interest level is not determined to be high, the AI will schedule a follow-up phone call based upon a default setting of a few days, a few weeks, or more, depending on the shopper's interest level in the product. The AI will follow-up with the salesperson to confirm whether or not the scheduled phone call occurred. If the scheduled phone call did not occur, then the AI will follow-up with the shopper to reschedule a phone call based on the salesperson's availability. Once a salesperson has connected with a shopper, no further action is required from the AI, unless the salesperson designates the shopper for a future follow-up from the AI based upon the salesperson's perception of the shopper's interest level in the product.

If a salesperson is not available then the AI will schedule a call with both the salesperson and the lead. The AI will also follow up with the salesperson and/or the lead to determine whether or not the schedule call occurred and if the schedule call did occur then no further action is required on the part of the AI if the scheduled call did not occur then the AI will reengage with both the lead and a salesperson to reschedule a call.

### BRIEF DESCRIPTION OF THE DRAWINGS

FIG. 1 is a flowchart representing the prior art method of connecting an online shopper with a salesperson.

FIG. 2 is a flowchart representing an embodiment of the present invention of connecting an online shopper with a salesperson.

FIG. 3A is the left portion of a flowchart representing a preferred embodiment of the present invention of connecting an online shopper with a salesperson.

FIG. 3B is the right portion of a flowchart representing a preferred embodiment of the present invention of connecting an online shopper with a salesperson.

### DETAILED DESCRIPTION

The description that follows includes exemplary apparatus, methods, techniques, or instruction sequences that embody techniques of the inventive subject matter. However, it is understood that the described embodiments may be practiced without these specific details.

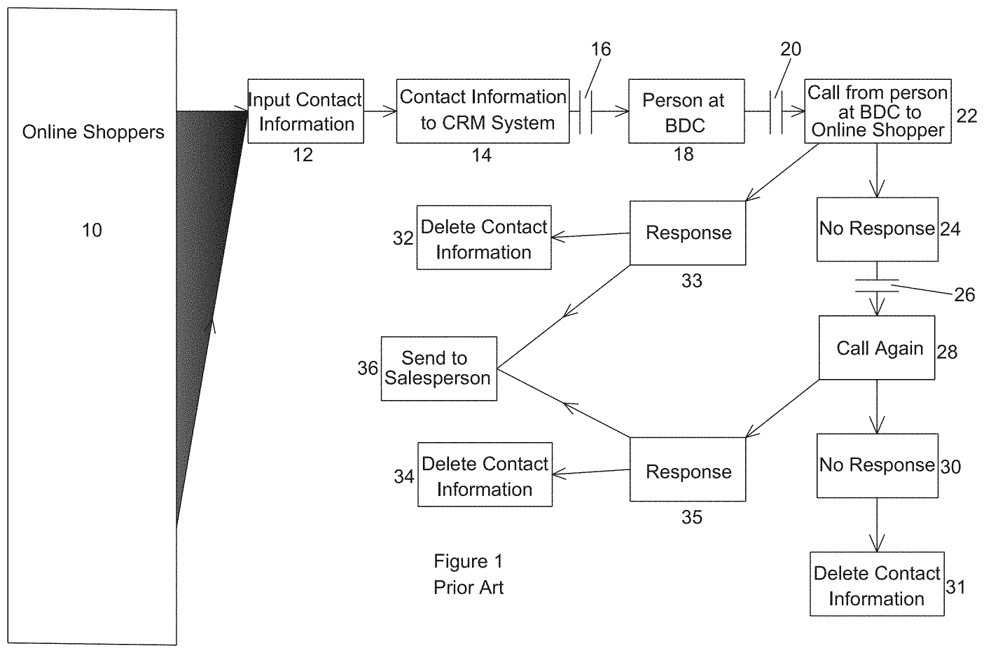

FIG. 1 is a flowchart describing the prior art where a multiplicity of shoppers, represented by box 10, generally numbering in at least the hundreds, go to one or more websites with links to a particular seller. Once the shopper opens a website, an opportunity is presented to the shopper to provide their contact information, as represented by box 12. That contact information is then copied to a customer relationship management system or CRM system, as represented by box 14. Generally, there is a delay, represented by gap 16, between the shopper providing their contact information to a particular person at the business development center or BDC. The delay may be attributable to the day or the time of day that the shopper is online viewing the various products. For instance, if the shopper provided their contact information while the shopper was online at 1 AM on Sunday morning, the shopper's contact information may not be provided to a person at the BDC until Monday morning. Moreover, in other instances, the shopper's contact information may not be assigned to a particular person at the BDC until a person at the BDC is available.

Once the shopper's contact information is provided to a particular person at the BDC, represented by box 18, there is generally another delay, represented by gap 20, between the information being assigned to the person at the BDC and the person at the BDC attempting to contact the online shopper. The gap 20 is generally attributable to the overwhelming number of shoppers providing contact information as compared to the number of persons at the BDC. It takes some finite amount of time, whether it's a large amount of time or a small amount of time, for the person at the BDC to open the file containing the shopper's contact information and then text, email, or phone the shopper. The amount of time it takes to attempt to contact each shopper that has provided their contact information, coupled with the disproportionate number of shoppers per person at the BDC while constantly receiving new shopper's contact information means that on average it takes a day or more for a person at the BDC to attempt to contact each shopper.

Once the particular shopper's contact information has made it to the front of the queue and the person at the BDC has the shopper's contact information, the person at the BDC will attempt to contact the shopper, as represented by box 22. When the person at the BDC attempts to contact the online shopper, they often receive no response, as represented by box 24. The lack of response may have occurred for several reasons. It could be due to incorrectly provided or copied shopper's contact information, it could be due to the shopper no longer being interested, or it could simply be a delay on the shopper's part in returning a text, an email, or a phone call that has gone to voicemail. If the person at the BDC receives no response from the shopper, the shopper's contact information is placed back in the queue where once again there is a delay, represented by gap 26, before another attempt is made to contact the particular shopper. When the person at the BDC attempts to contact the particular shopper again, as represented by box 28, they, once again, often receive no response, as represented by box 30. Depending upon the instructions received by the person at the BDC, a number of other attempts may be made to contact the particular shopper or the shopper's contact information may be considered a dead end and is then deleted, as represented by box 31.

Returning now to box 22 and/or box 28, in certain instances the person at the BDC will receive a response from the shopper, as represented by box 33 and/or box 35. In a number of instances, the shopper may no longer be interested due to the passage of time or having purchased a product elsewhere. In such case, the shopper's contact information is deleted, as represented by boxes 32 and 34. However, in other instances, the shopper continues to be interested in a particular product of the seller and, in such a case, the person at the BDC will forward the shopper's contact information to an appropriate salesperson, as represented by box 36.

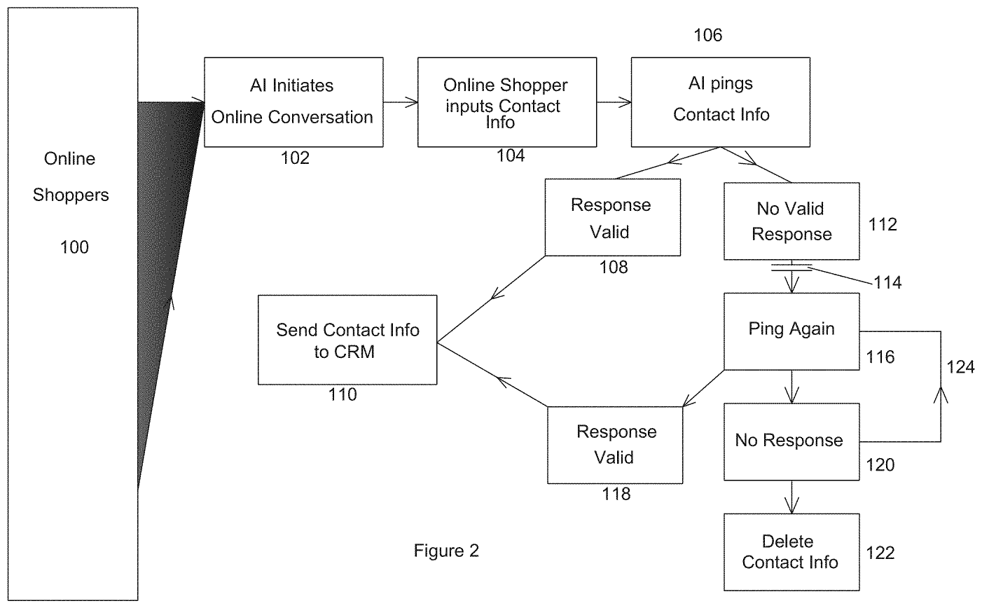

FIG. 2 is a flowchart representing an embodiment of the present invention where a multiplicity of shoppers, represented by box 100, again, generally numbering in at least the hundreds, go to one or more websites with links to a particular seller. Once the shopper opens a website, a computerized artificial intelligence or AI utilizes language recognition software to initiate an online conversation with the shopper, as represented by box 102. It has been found that having an AI use language recognition software to emulate a human is more likely to induce a shopper to provide their contact information than if the shopper believes they are interacting with a computer. During the course of the conversation between the online shopper and the AI, an opportunity is presented to the online shopper to provide their contact information to the AI, as represented by box 104. Once the online shopper has provided their contact information to the AI, then the AI will validate the shopper's contact information, as represented by box 106. In the event that the shopper's contact information is valid, as represented by box 108, then the contact information is copied to the customer relationship management system, as represented by box 110. In the event that no response or an invalid response is returned to the AI, as represented by box 112, then the AI will wait for some predetermined amount of time, as represented by gap 114, and will then make another attempt to validate the shopper's contact information, as represented by box 116. In the event that the shopper's contact information is valid, as represented by box 118, then the contact information is copied to the customer relationship management system, as represented by box 110. In the event that a second no response or invalid response is received by the AI, as represented by box 120, the AI may delete the shoppers contact information, as represented by box 122. In some instances, additional attempts may be made by the AI to validate the shopper's contact information, in which case, box 120 may loop back into box 116, as represented by line 124.

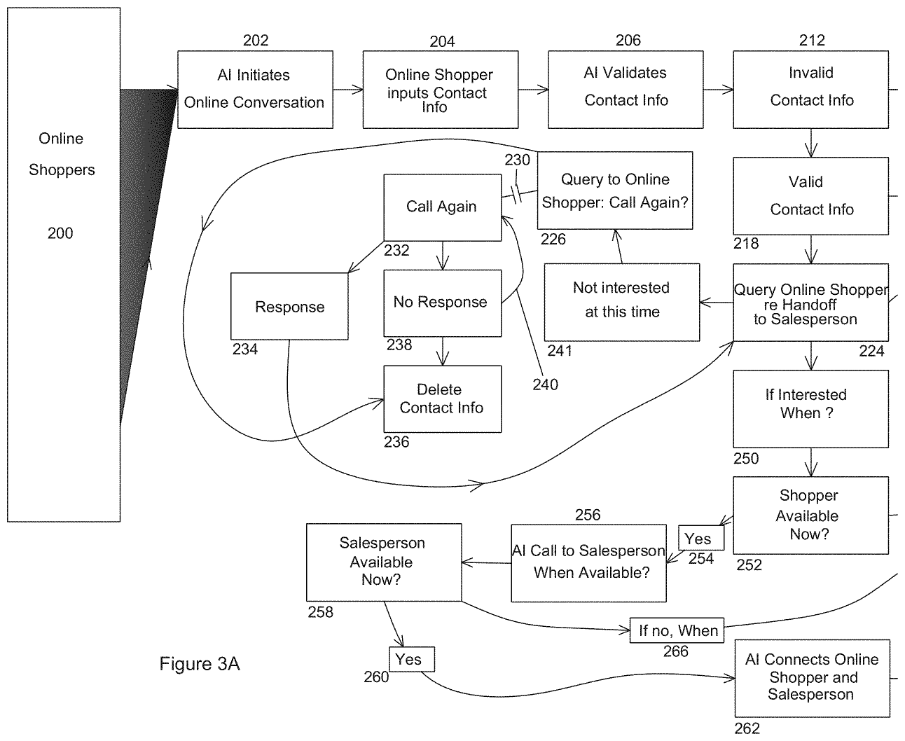

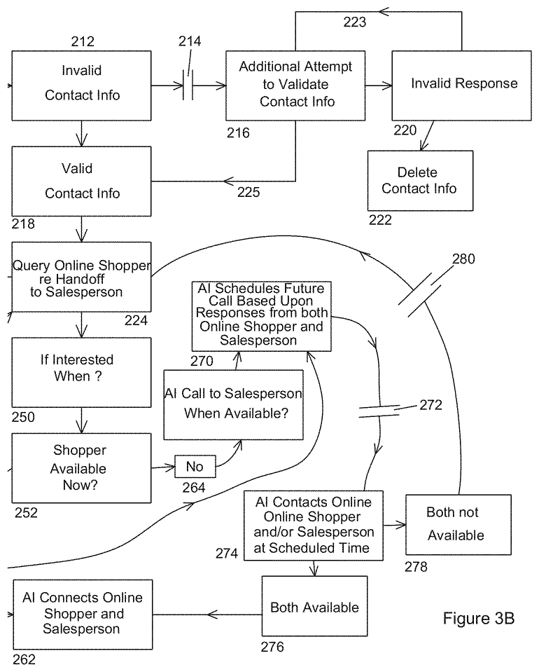

FIGS. 3A and 3B are a flowchart representing an embodiment of the present invention where a multiplicity of shoppers, represented by box 200, again, generally numbering in at least the hundreds, go to one or more websites with links to a particular seller. Once the shopper opens a website, an AI uses language recognition software to initiate an online conversation with the shopper, as represented by box 202. During the course of the conversation between the online shopper and the AI, an opportunity is presented to the online shopper to provide their contact information to the AI, as represented by box 204. Once the online shopper has provided their contact information to the AI, the AI validates the shopper's contact information, as represented by box 206. In the event that no response or an invalid response is returned to the AI, as represented by box 212, then the AI will wait for some predetermined amount of time, as represented by gap 214, and will make another attempt to validate the shopper's contact information, as represented by box 216. In the event that an additional no response or invalid response is received by the AI, as represented by box 220, the AI may delete the shopper's contact information, as represented by box 222. In some instances, additional attempts may be made by the AI to validate the shopper's contact information, in which case, box 220 may loop back to box 216, as represented by line 223. In the event that the additional attempt to validate a shopper's contact information is successful then AI will move the particular shopper's information from box 216 to box 218, valid contact information as represented by line 225.

In the event that the shopper's contact information is valid, as represented by box 218, then the AI will query the online shopper as to whether or not the shopper is interested in discussing the products with a salesperson, as represented by box 224. If the shopper is not interested in talking with the salesperson at the time, as represented by box 241, the AI will query the shopper as to whether or not the shopper is interested in being contacted in the future, as represented by box 226. If the shopper is interested in being contacted in the future, after some delay, as represented by gap 230, the AI will contact the shopper again, as represented by box 232. If the shopper is not interested in being contacted in the future, than the AI will delete the shopper's contact information, as represented by box 236. Provided that the online shopper responds to the follow-up contact, represented by box 234, the AI will again query the online shopper as to whether or not the shopper is interested in discussing the products with a salesperson, as represented by box 224. If the shopper is not interested in talking with the salesperson, then the AI loops back to asking the shopper as to whether or not the shopper is interested in being contacted in the future, as represented by box 226. If the shopper is interested in being contacted again in the future, after some delay, as represented by gap 230, the AI will call the shopper again, as represented by box 232, until a preset number of loops are reached. If during the follow-up contact, represented by box 232, there is no response from the shopper, as represented by box 238, then the AI will continue to follow-up with the shopper, as represented by arrow 240, or, if the preset number of loops are reached, the AI will delete the shopper's contact information, as represented by box 236.

If the shopper indicates an interest in further discussions with a salesperson during the online conversation with the AI, as represented by box 224, the AI will attempt to determine when the shopper would prefer to speak with the salesperson, as represented by box 250. The AI will attempt to determine whether or not the shopper is immediately available to have a phone call with the salesperson, as represented by box 252. If the shopper indicates that they are immediately available, as represented by box 254, the AI will place a phone call to the appropriate salesperson, as represented by box 256, to determine whether or not the salesperson is immediately available, as indicated by box 258. If the salesperson is immediately available, as indicated by box 260, and the shopper has indicated that they are immediately available, as previously represented the box 254, the AI will connect the online shopper and the salesperson, as indicated by box 262, all within minutes of the online shopper visiting the website in search of a product as represented by box 200. If the salesperson is not immediately available, as indicated by box 266, the AI will then use the information from both the online shopper and the salesperson to schedule a call between the salesperson and the online shopper, as indicated by box 270.

If the shopper indicates an interest in further discussions with a salesperson during the online conversation with the AI, as represented by box 224, and the AI has determined that the shopper would like to speak with a salesperson, as represented by box 250, but the shopper is not immediately available, as indicated by box 264, the AI will attempt to determine when the shopper would prefer to schedule a future conversation with a salesperson. While the AI is engaged with the shopper, or shortly thereafter, the AI will contact a salesperson to determine when the salesperson is available, as indicated by box 256. The AI will then use the information from both the online shopper and the salesperson to schedule a call between the salesperson and the online shopper, as indicated by box 270. After waiting an appropriate amount of time to reach the scheduled time of the phone call, as represented by gap 272, the AI will contact the online shopper and/or the salesperson at the scheduled time, as indicated by box 274. Provided that both the online shopper and the salesperson are available at the scheduled time, as represented by box 276, the AI will then connect the online shopper and the salesperson as indicated by box 262. In the event that either the online shopper or the salesperson is not available at the scheduled time, as represented by box 278, then the AI will wait some predetermined amount of time, as represented by gap 280, and will again contact the online shopper regarding the handoff to a salesperson, as represented by the line looping back into box 224 from gap 280.

Although an embodiment of the present invention has been described herein with reference to specific exemplary apparatus, methods, techniques, or instruction sequences that embody techniques of the inventive subject matter, it will be evident that various modifications and changes may be made to these embodiments without departing from the broader spirit and scope of the invention. Accordingly, the specification and drawings are to be regarded in an illustrative rather than a restrictive sense. The accompanying figures that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This description, therefore, is not to be taken in a limiting sense, and the scope of the various embodiments is defined only by the appended claims, along with the full range of equivalents to which such claims are entitled.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

1. A method for identifying online shoppers comprising:
accessing a website by a multiplicity of online shoppers,
wherein the website advertises a product,
engaging in concurrent multiple conversations between each of a multiplicity of online shoppers and an artificial intelligence,
receiving a contact information for each of a multiplicity of online shoppers,
validating the contact information for each multiplicity of online shoppers by the artificial intelligence.

2. The method for identifying online shoppers of claim 1 wherein, the artificial intelligence includes a language recognition program.

3. The method for identifying online shoppers of claim 1 wherein, the language recognition program allows the artificial intelligence to interact with answers other than yes or no.

4. The method for identifying online shoppers of claim 1 wherein, the website includes at least 2 websites.

5. A method for identifying and connecting with online shoppers comprising:
accessing a website by a multiplicity of online shoppers,
wherein the website advertises a product,
engaging in concurrent multiple conversations between each of a multiplicity of online shoppers and an artificial intelligence,
receiving a contact information for each of a multiplicity of online shoppers,
connecting a call between a salesperson and an online shopper.

6. The method for identifying online shoppers of claim 5 wherein, the artificial intelligence includes a language recognition program.

7. The method for identifying online shoppers of claim 5 wherein, the language recognition program allows the artificial intelligence to interact with answers other than yes or no.

8. The method for identifying online shoppers of claim 5 wherein, the website includes at least 2 websites.

9. The method for identifying online shoppers of claim 5 further comprising the artificial intelligence validating each of the online shopper's contact information.

10. The method for identifying online shoppers of claim 5 further comprising contacting the salesperson to determine the salesperson's availability.

11. The method for identifying online shoppers of claim 5 further comprising determining the online shopper's interest in contact with the salesperson and scheduling the call between the salesperson and the online shopper.

12. The method for identifying online shoppers of claim 5 further comprising determining each of the online shopper's availability, the salesperson's availability, and scheduling the call between the salesperson and the online shopper based upon each of the online shopper's and the salesperson's availability.
